(19) United States
(12) Patent Application Publication
(10) Pub. No.: US 2026/0045143 A1
(43) Pub. Date: Feb. 12, 2026

(54) SYSTEMS AND METHODS FOR GENERATING AN OPTIMIZED PAYOUT ACTION PLAN BASED ON DATA DETECTED FROM RFID ELEMENTS OF A GAMIING TABLE

(71) Applicant: Walker Digital Table Systems, LLC, Las Vegas, NV (US)

(72) Inventors: Stephen Moore, Las Vegas, NV (US); Todd Alan Wingate, Las Vegas, NV (US); Carolyn Moore, Las Vegas, NV (US)

(21) Appl. No.: 19/362,177

(22) Filed: Oct. 17, 2025

Related U.S. Application Data
(63) Continuation of application No. PCT/US24/25163, filed on Apr. 18, 2024.
(60) Provisional application No. 63/460,310, filed on Apr. 18, 2023.

(51) Int. Cl. G07F 17/32

(52) U.S. Cl. CPC G07F 17/3244; G07F 17/3225

(57) ABSTRACT

Systems and methods for facilitating an electronic game by generating a payout action plan for a game event that requires a net payout to be provided to at least one player. In accordance with some embodiments, a payout action plan utilizes a payout efficiency optimization rule designed to optimize the efficiency of how the dealer provides the appropriate payout due to a particular player and/or all payouts due to all players for the particular game event (e.g., by minimizing the amount of dealer movements and/or the number of gaming elements to be handled by the dealer in providing the net payout). In some embodiments, a payout action plan or other information may be output to a dealer via a Mixed Reality (MR) or Virtual Reality (VR) device.

### CLAIM OF PRIORITY

The present application is a Continuation Application of PCT Application No. PCT/US24/25163 titled SYSTEMS AND METHODS FOR GENERATING AN OPTIMIZED PAYOUT ACTION PLAN BASED ON DATA DETECTED FROM RFID ELEMENTS OF A GAMING TABLE, filed Apr. 18, 2024, which PCT Application claims priority to U.S. Provisional Application No. 63/460,310, filed on Apr. 18, 2023 in the name of Moore et al. and titled SYSTEMS AND METHODS FOR GENERATING AN OPTIMIZED PAYOUT ACTION PLAN BASED ON DATA DETECTED FROM RFID ELEMENTS OF A GAMING TABLE. The entirety of each of these Applications is incorporated by reference herein for all purposes.

### INTRODUCTION AND SUMMARY OF SOME EMBODIMENTS

Some of the embodiments provided herein are directed to an electronic gaming table system (e.g., a smart table operable to facilitate a card game, such as baccarat, blackjack or poker) which includes (i) at least one first detecting mechanism for detecting a plurality of gaming elements (e.g., wagering chips) placed on, or removed from, a particular physical position of a physical table of the gaming table system, such as an RFID antenna at a dealer position or area; (ii) at least one second detecting mechanism for detecting a current inventory of a dealer chip tray, such as an RFID antenna corresponding to the chip tray; and (iii) a game controller operable to (a) identify the specific number and denomination of wagering chips placed at respective player positions as wagers on a particular game event based at least on data received from the at least one detecting mechanism, and determine an outcome for each such wager as a result of the particular game event; (b) determine, based on the result of the game event and for each player position, the specific number and denomination of wagering chips that a dealer is to provide and/or remove from each player position in order to effectuate a net payout in a manner that satisfies at least one payout efficiency optimization rule, thereby generating a payout action plan (also referred to as an optimized payout action plan) for the game event; and/or (c) determine, based on the known player ownership of chips, the players entire available set of chips in the player's possession

In accordance with some embodiments, a payout efficiency optimization rule is designed to optimize the efficiency of how the dealer provides the appropriate payout due to a particular player and/or all payouts due to all players for the particular game event. For example, a payout efficiency optimization rule may define optimized payout efficiency as having the dealer provide the appropriate payout(s) using as few wagering chips of different denominations as possible, given base chip data. In some embodiments the payout efficiency optimization rule may define leaving one or more losing wagers when the winning wagers payouts are greater than the losing wagers and having the dealer provide net amount using as few wagering chips as possible. In some embodiments, base chip data may comprise one or more of (i) data defining the wagering chips (including number and denomination of each) currently in inventory in the wagering chip tray of the table system (e.g., as determined via the at least one second detecting component); and (ii) data defining the wagering chips (including number and denomination of each) placed/wagered by a given player on a player position on the game event (e.g., as determined via the at least one first detecting component).

In accordance with some embodiments, the electronic gaming table system may additionally be operable to determine a bankroll of a particular player to whom a payout is due. In such embodiments, the base chip data may comprise data defining the wagering chips (including number and denomination of each) in a bankroll of a given player and a payout efficiency optimization rule may comprise a rule that provides for the dealer to remove one or more wagering chips from the player bankroll (or requesting the player to provide such wagering chips from the bankroll to the dealer) as part of providing the payout due to the player or is directed to replenishing chips of a particular denomination into the player bankroll. For example, a payout efficiency optimization algorithm may determine that an optimized payout action plan should instruct a dealer to provide to a particular player more of a specific denomination chip that the system recognizes as being a favored one that the player historically uses for making wagers because the player's known owned set of chips (the player's bankroll) is low or out of chips of that specific denominations.

Once the system determines the payout action plan for a game event, in accordance with the one or more payout efficiency optimization rules, the system may be further operable to output the payout action plan to the dealer in the form of one or more instructions. The instructions may comprise instructions regarding (i) a particular player and/or player position and/or (ii) all players and/or player positions participating in the game event.

In one embodiment, the controller may be programmed with an algorithm comprising one or more payout efficiency optimization rules, such as having the dealer use the least amount of different wagering chips as possible while leveraging dealer motions already in progress or anticipated to be made by the dealer.

For example, the dealer may be instructed, for a particular player and player position at the end of a game event, to “pay $100, take $25” based on RFID data indicating the particular wagering chips the player wagered, including the denominations of those chips. For example, assuming the player wagered $135 using four (4) wagering chips having corresponding respective denominations of $100, $25, $5 and $5, if the payout/win due to the player as a result of the game event is $75, the controller may determine that the optimized payout action plan is to have the dealer provide to the player one (1) wagering chip of denomination $100 and take from the player the one (1) wagering chip of denomination $25 that is on the player position as part of the wager (e.g., this may be determined to be an action plan that will require less time than having the player take three (3) wagering chips of denomination $25 from the chip tray inventory). Similarly, if in the preceding example the payout/win had been $95, the controller may determine that the optimized payout action plan is to have the dealer provide to the player one (1) wagering chip of denomination $100 and remove one of the wagering chips of denomination $5, because this may be determined to take less time than an alternative of having the dealer remove from the chip tray (and pay to the player) three (3) wagering chips of denomination $25 plus an additional four (4) wagering chips of denomination $5, etc.

It should be noted that although a currency of USD ($) are used in the above example to illustrate the example wagering chip denominations, any currency may be used and the embodiments described herein are agnostic to currency being utilized.

With a complex set of data and variables to take into account (e.g., current chip inventory, the particular chips that make up a particular wager, variable odds bets, commissions, etc.) an appropriately programmed controller is required to, in less than a second, determine the optimal payout action plan which results in not only the correct net amount being paid to each player but also a determination of the optimal combination of wagering chips to be paid and/or collected (e.g., by calculating what specific wagering chips to collect from a given player based on what the player wagered while also minimizing the different denominations being removed from the chip tray).

The game controller may further be operable to output to a dealer of the electronic gaming table system, specific instructions that specify the payout action plan per player and/or player position (e.g., the number and corresponding denomination of the wagering chips that the dealer is to provide and/or remove from each impacted player position). For example, the dealer may be provided such instructions via a headset, virtual reality glasses, a heads-up display and/or a screen of a dealer device.

In some embodiments, different phases or sub-events during a game, hand or game event can trigger at least a portion of a payout action plan to be determined and/or instructed. For example, in one embodiment a first position payout instruction may be trigger by the outcome from a smart shoe of the table system and the next position payout instructions may be triggered by the successful RFID confirmation of a successful execution by the dealer of a pervious payout action plan.

It should be noted that throughout the description herein, reference may be made to a “game controller”, “controller”, “system” or “casino game system” (CGS) performing a particular action or step. It should be understood that such references are for illustrative purposes only and that any such action or step described as being performed by a game controller may be performed by any component, or combination of components, of the table system described herein, as desired or appropriate.

### BRIEF DESCRIPTION OF THE DRAWINGS

FIG. 1 illustrates an example system operable to facilitate at least some embodiments described herein.

FIG. 2 illustrates a diagram of an RFID antenna layout on a smart table for facilitating a baccarat game, in accordance with some embodiments.

FIG. 3 illustrates a top planar view of a smart table for facilitating a baccarat game, in accordance with some embodiments.

FIG. 4 illustrates a block diagram of a table system operable to facilitate at least some embodiments described herein.

FIG. 5 illustrates a flow diagram of an example process consistent with at least some embodiments described herein.

FIG. 6 illustrates an example system for outputting information to a dealer of a smart table, in accordance with some embodiments described herein.

### DETAILED DESCRIPTION OF EXAMPLE EMBODIMENTS

The present embodiments are directed to tracking of activity at table games and within a gaming establishment, using radio frequency identification (RFID) technology, near field communication (NFC) or optical reading technology to track and manage RFID-enabled or other identifiable wagering chips (also referred to as “chips” herein) and wagering activity utilizing such chips and particularly to develop an optimized payout action plan for a game event being conducted via a dealer antenna or other detecting component of such a table, and output instructions for the payout action play to a dealer facilitating the game event.

In some embodiments, systems are provided which perform functions responsive to data obtained via a detecting component of the table, such as an RFID antenna operable to read data from RFID-enabled chips, an NFC antenna operable to read data from an NFC tag of a chip or an optical reading component operable to read data from a wagering chip having optical data encoded thereon. In particular, data read by an RFID antenna or other detecting component at a dealer position, respective player position and/or chip tray inventor (collectively “chip location positions”) is utilized to obtain a unique identifier of chips located at such position(s). Wagering chips are referred to as being located on a given antenna or detecting component when they placed in an area of the table such that they are within a detection range of such antenna.

It should be noted that chips described as being detected “on” or “at”, or being “present at” a given antenna or other detecting component or being present on a “dealer antenna” are intended to convey that such chips have been detected or recognized by that detecting component of a table as being within a particular area of a table (e.g., within an area in which a player places chips being wagered on a given game event of the table). The use of the term “antenna” is not intended to reference any particular type of technology being utilized to so detect or identify the presence of such chips. Thus, whether a detecting component comprises an RFID antenna, an NFC detecting mechanism, an optical recognition reader or other technology, for purposes of brevity, recognition by such detecting component of chips within an area of detection corresponding to such detecting component is referred to as recognition by an antenna of chips being “on the antenna”, being “placed on the antenna” or being recognized “by the antenna.”

It should be noted that a “bet spot” or a “wager placement position” or “player position”, whether physical or virtual, refers to an area of a card game table or an area of a virtual card game representation (e.g., a graphical representation of a virtual table) on which a representation or indication of a wager may be placed or output. Thus, for example, a bet spot, wager placement position or player position may comprise a specifically designated or identifiable area on which a player may place at least one gaming element (e.g., a wagering chip, “chip” or token) to indicate placement of a wager. It should further be noted that a gaming element may be a physical wagering element (e.g., a physical wagering chip, in the context of a physical table) or a virtual wagering element (e.g., a graphical representation of a wagering chip, as may be depicted on a graphical representation of a virtual table). In some embodiments, reference is made to “wagering chips” or “chips” which reference should be understood to refer to either physical wagering chips or virtual wagering chips, depending on the context. Although at times embodiments are described with reference to wagering chips or simply “chips”, such embodiments can also be implemented using other types of gaming elements (e.g., tokens, lammers, etc.) useful for indicating placement of a wager and the embodiments described herein are not dependent on any particular form of gaming element for indicating placement of a wager.

In accordance with some embodiments, wagering chips that are detectable at an electronic table system as described herein comprise RFID-enabled wagering chips that include RFID components operable to store data readable by an RFID detecting component (e.g., an antenna). In other embodiments, wagering chips that are detectable at an electronic table system comprise wagering chips that include optically readable data that is readable by an optical imaging component (e.g., an imager or camera). In either embodiment, the detecting component (whether it be an RFID detecting component, an optical imaging component or another type of detecting component) may be operable to communicate data it receives from the wagering chips, or otherwise reads or determines from the wagering chips, to a game controller or processor. In yet other embodiments, the detecting component may comprise different technology, such as an NFC antenna operable to communicate with, or read data from, NFC tags included on one or more wagering chips. For purposes of clarity, some embodiments will be described herein with reference to RFID-enabled wagering chips but it should be understood that such embodiments may also be implemented using wagering chips comprising other technology, in lieu of or in addition to RFID technology. For example, gaming elements may, in some embodiments, have optically readable data encoded or represented thereon and the table may comprise an optical imaging detecting component or gaming elements may include an NFC tag and the table may comprise an NFC antenna detecting component.

In accordance with some embodiments, an electronic table system for facilitating a game comprises (i) at least one physical table including a first number of physical wager placement positions, each of the physical wager placement positions corresponding to a respective area of a physical table surface on which a gaming element may be placed in order to indicate a particular wager made by a player (e.g., player wagers on “Player” outcome in a baccarat deal or player places a wager on a hand of blackjack); (ii) a detecting mechanism operable to detect a gaming element being placed on and removed from a particular physical wager placement position of the first number of physical wager placement positions; (iii) a display device; and (iv) a game controller operable to track multiple distinct wagers placed on a particular game event by respective players.

In accordance with some embodiments, a system is provided which includes at least one table having a plurality of RFID detecting component (e.g., an RFID antenna) placed thereon, for use in recognizing the placement of an RFID-enabled wagering chip or other gaming element on one or more wager placement positions of the table or associated with other components or areas of the table (e.g., an RFID-enabled chip tray). In accordance with other embodiments, the system includes (in lieu of or in addition to the RFID detecting component(s)), at least one optical image detecting component for detecting, via optical imaging technology, at least one wagering chip or other gaming element on the one or more wager placement positions of the table or elsewhere on the table (e.g., within a chip tray).

A table system comprising RFID components may be referred to herein as an RFID-enabled table. An RFID-enabled table, as the term is used herein, comprises a table operable to facilitate a game (e.g., a card game such as baccarat or blackjack) and equipped with at least one RFID antenna or other RFID component (described in more detail elsewhere herein). In other embodiments, the table system may be an imaging-enabled table or include other types of technology that serves as the mechanism via which data (e.g., wagering data or other game-related data) is gathered by the table system.

Examples of an RFID-enabled table that may be useful for at least some embodiments described herein are described in (i) U.S. Patent Publication No. 2016/0016071, filed on Sep. 28, 2015 in the name of Walker et al. and entitled RFID SYSTEM FOR FACILITATING SELECTIONS AT A GAME APPARATUS; (ii) U.S. Pat. No. 9,262,885 filed on Jun. 5, 2012 in the name of Moore et al. and entitled METHODS AND SYSTEMS FOR FACILITATING TABLE GAMES, each of which is incorporated by reference herein. Some examples of other technologies (such as optical imaging technologies) that may be utilized to implement at least some embodiments described are described in the following patents: (i) U.S. Pat. No. 5,782,647 to Fishbine et al.; (ii) U.S. Pat. No. 5,103,081 to Fisher et al; (iii) U.S. Pat. No. 5,548,110 to Storch et al.; and (iv) U.S. Pat. No. 4,814,589 to Storch et al. Each of the foregoing patents are incorporated by reference herein and disclose various systems and methods for encoding information on wagering chips or other gaming elements and for determining information encoded in the color, geometry, size or patterns on a wagering chip in accordance with some embodiments described herein.

A table that is equipped with RFID-enabled technology, optical imaging technology or other technology that allows reading of data from one or more gaming elements used for games playable on the table is referred to as an electronic table or a smart table herein. For purposes of clarity, the example embodiments described herein will primarily refer to an RFID-enabled table but it should be understood that some embodiments may alternately be implemented using an optical imaging-enabled electronic table that utilizes imaging technology to read data from gaming elements (e.g., to read bar codes or other codes embedded in or included on one or more wagering chips). The embodiments described herein are not limited to implementations utilizing RFID or optical imaging technology, other technologies may be substituted for detecting the presence (or removal of) a wagering chip(s) on a player position or bet spot, as well as for reading data from the wagering chip(s).

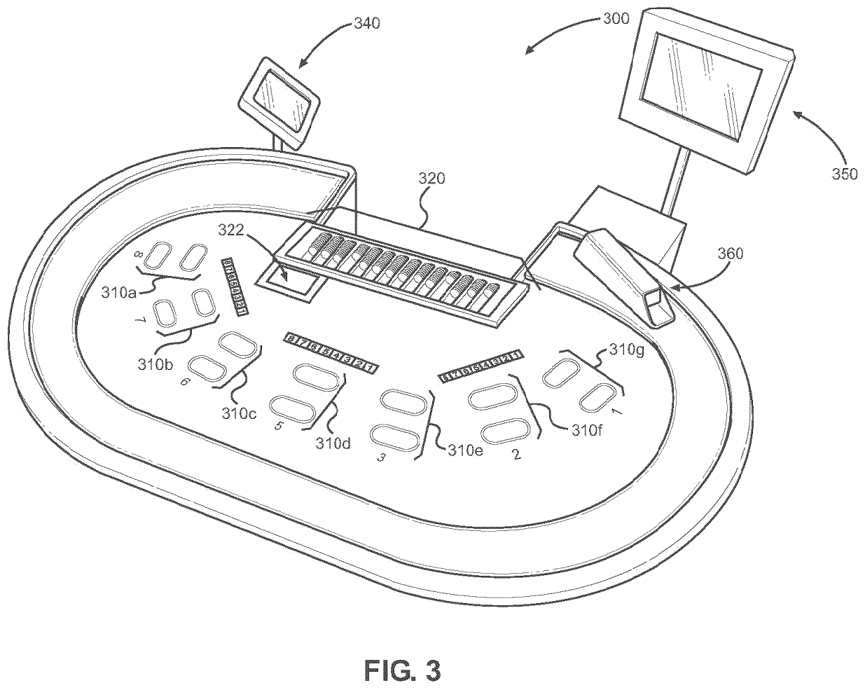

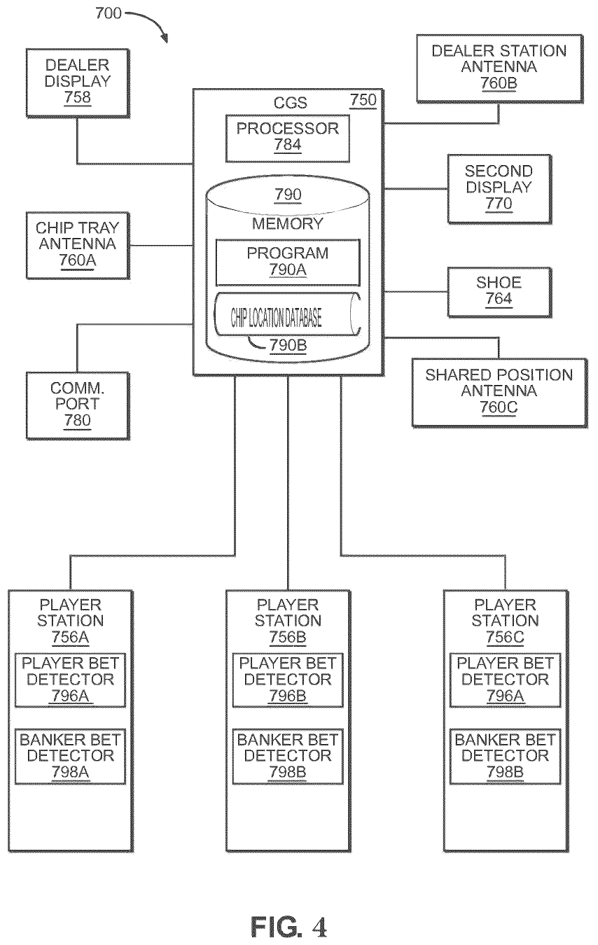

In accordance with some embodiments, a smart table system includes a dealer display (e.g., as illustrated in FIG. 3), which may comprise a display facing the dealer and for outputting information to the dealer (such as instructions for an optimized payout action plan determined by the controller). The dealer display may, in some embodiments, be operable to receive data and/or instructions from a processor (e.g., a processor integrated with the dealer display, a processor of CGS 750 (FIG. 4) or another game controller, another processor of the table at which the dealer display is located and/or a remote processor of a server device) and to output information to the dealer based on this data and/or instructions. The data and/or instructions may be based on data read from one or more RFID-enabled chips in the RFID-enabled chip tray, the RFID antenna of the dealer area of the table or elsewhere on the table.

Various systems and several examples are provided herein. The present disclosure will focus on baccarat as an example, but it should be appreciated that similar functionality may be applied to other RFID-enabled table games such as blackjack, roulette, craps, Sic Bo, Pai Gow (tile and poker variations), LET IT RIDE™, CARIBBEAN STUD™, 3-CARD POKER, 4-CARD POKER, SPANISH 21, variants of such games (e.g., Chemin de Fer), and the like.

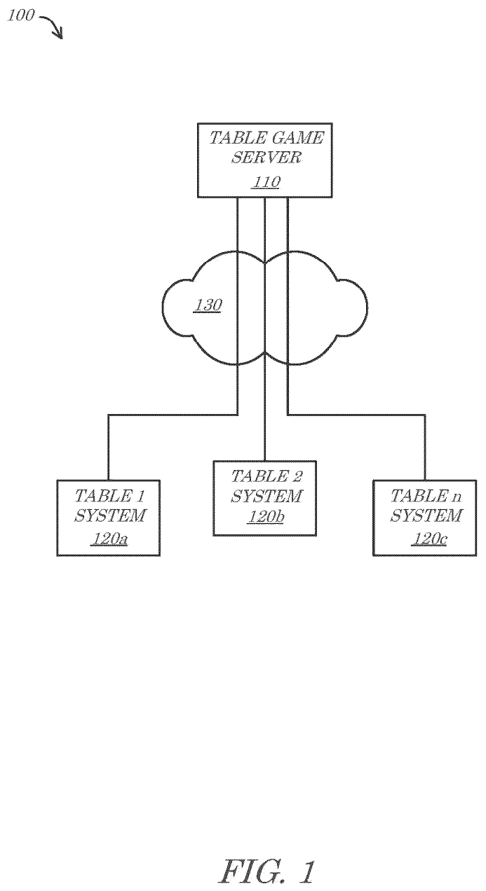

Referring now to FIG. 1, illustrated therein is a system 100 which may be useful in implementing at least some embodiments described herein. The system 100 may comprise, for example, a system within a particular gaming establishment which includes a plurality of smart tables for facilitating card games. In accordance with at least some embodiments, the system 100 includes a table game server 110 (e.g., for managing chip, player and/or game activities at one or more connected smart tables, providing data for a particular player placing a wager at a table from a global player database, etc.) that is in communication, via a communications network 130, with one or more table systems 120. The table game server 110 may communicate with the table systems 120 directly or indirectly, via a wired or wireless medium such as the Internet, LAN, WAN or Ethernet, Token Ring, or via any appropriate communications means or combination of communications means. Each of the table systems 120 may comprise computers, such as those based on the INTEL® PENTIUM® processor, that are adapted to communicate with the table game server 110. Any number and type of table systems 120 may be in communication with the table game server 110, although only three (3) are illustrated in the example of FIG. 1.

Communication between the table systems 120 and the table game server 110, and (in some embodiments) among the table systems 120, may be direct or indirect, such as over the Internet through a Web site maintained by table game server 110 on a remote server or over an on-line data network including commercial on-line service providers, bulletin board systems and the like. In yet other embodiments, the table systems 120 may communicate with one another and/or table game server 110 over RF, cable TV, satellite links and the like.

Some, but not all, possible communication networks that may comprise network 130 or otherwise be part of system 100 include: a local area network (LAN), a wide area network (WAN), the Internet, a telephone line, a cable line, a radio channel, an optical communications line, a satellite communications link. Possible communications protocols that may be part of system 100 include: Ethernet (or IEEE 802.3), SAP, ATP, Bluetooth™, and TCP/IP. Communication may be encrypted to ensure privacy and prevent fraud in any of a variety of ways well known in the art.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet may not transmit data to the other device for weeks at a time.

In some embodiments, the table game server 110 may not be necessary and/or preferred. For example, at least some embodiments described herein may be practiced on a stand-alone table system 120 and/or a table system 120 in communication only with one or more other table systems 120 or a dedicated server device. In such an embodiment, any functions described as performed by the table game server 110 or data described as stored on the table game server 110 may instead be performed by or stored on one or more table systems 120.

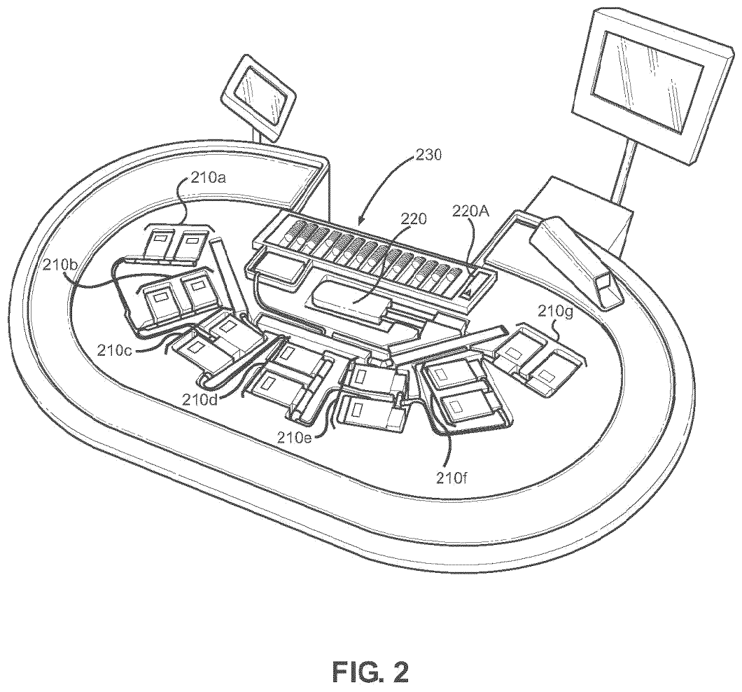

Referring now to FIG. 2, illustrated therein is one embodiment of how a plurality of antennas may be placed on a table (which may be one embodiment of table system 120 of FIG. 1), in a manner that facilitates some of the embodiments described herein. The table illustrated in FIG. 2 includes seven (7) distinct player positions arranged in a semi-circular configuration. Placed at each respective player position is a set of two antennas 210a-210g, one for each bet spot or wager placement position available at each respective player position. For example, one antenna at a respective wager placement position at a particular player station (e.g., area of a physical table in front of a particular player seat) may be for recognizing a bet on Banker (e.g., recognizing RFID-enabled chips placed on the Banker bet spot) and the other antenna may be for recognizing a bet on Player (e.g., recognizing RFID-enabled chips placed on the Player bet spot). Thus, if a player were to place a wager (e.g., one or more RFID-enabled chips, a stack of chips) on a bet spot associated with one of the antennas at the wager placement position associated with the set of antennas 210a, the appropriate antenna (Banker bet antenna or Player bet antenna) would recognize such placement (i.e., the antenna nearest to which the chips are placed would “acquire” the chip(s) comprising the wager).

The table illustrated in FIG. 2 further comprises a dealer area at which is positioned an antenna 220. The dealer area antenna 220 may facilitate, for example, change transactions, calculations and verifications of stack totals for table fills, credits and buy-ins (e.g. by reading and providing data regarding one or more chips acquired by the dealer area antenna 220).

In some embodiments, a smart table such as that illustrated in FIG. 2 may include an RFID-enabled chip tray 230 within which is placed at least one antenna 220A. In one embodiment, the chip tray antenna(s) 220A may interact with the dealer area antenna 220 (or a processor which receives data from both the chip tray antenna(s) 220A and the dealer area antenna 220 may take into account the data of the antenna(s) 220A along with the data of the antenna 220) to ensure that wagering chips implicated in certain transactions (e.g., wagering chips included in a fill transaction) are actually recognized as having been placed into the chip tray after being counted and confirmed on the dealer antenna.

The antennas incorporated into a table such as the table illustrated in FIG. 2 may be placed within an insert under the felt or other covering of the table. Each antenna may have a predetermined range within which it recognizes, determines, identifies or acquires a chip. Thus, if one or more chips comprising a wager is placed within the acquire range of a particular antenna, it may be inferred or determined that a player (e.g., the player who is associated with the acquired chip(s)) is placing a bet on the bet spot associated with the antenna.

It should be noted that the number and placement of antennas illustrated in FIG. 2 is exemplary only and should not be construed in a limiting manner. An antenna such as any of those illustrated with respect to FIG. 2 may determine, read, receive, obtain, recognize or determine various information or data from or about an RFID-enabled chip placed within a predetermined range of the antenna. The following are examples or some of the information or data that may be so determined: (i) a unique chip identifier, which uniquely identifies the chip (and which may be utilized to determine additional information associated with the chip, such as a status of the chip as stored in a database); (ii) a currency of the chip; (iii) a denomination of the chip (which may be its monetary value; in the case of a token it may comprise the token type); (iv) a chip set identifier, which differentiates types of chips or represents a category of a chip (e.g., cash vs. non-negotiable, promotional, differentiating tokens from monetary chips, chip validity); (v) a casino identifier that uniquely identifies a casino or other registered gaming corporation associated with the chip (this information may also be used to determine chip validity); and (vi) a site identifier that uniquely identifies the physical casino site for which the chip is valid. It should be noted that not all of the above information is necessary or desirable for all embodiments. It should further be noted that any or all of the above-listed information may be stored in a memory of a given chip and transmitted to an antenna via a signal from the chip.

An RFID-enabled chip which may be used in at least some embodiments may include (i) an RFID tag or memory, (ii) an electronic circuit or processor and (iii) an antenna. An RFID-enabled chip usable in at least some embodiments may be similar or identical to those disclosed in U.S. Pat. Nos. 5,166,502; 5,676,376; 6,021,949; and 6,296,190, and U.S. Patent Application Publication Nos. 2004/0207156 and 2004/0219982 which are all incorporated by reference in their entireties. No particular type of RFID-enabled chip is required for the embodiments described herein, so long as the chip can support the functionality described with respect thereto. In some embodiments, each chip may store in its memory (and communicate to, or make available for reading by, an antenna or other detecting component of a table as described herein) a unique serial number, a chip set identifier, an associated player identifier or other information. The gaming establishment (e.g., casino) or other entity may associate values, categories, denominations or other values with each serial number. The association may be in a look-up table or the like. Alternatively, the unique identifier of a given chip may be encoded to include information therein. Likewise, a chip may be color-coded or include other indicia that indicates a value or other information to the player or dealer. In some embodiments, other types of gaming elements such as plaques may be used instead of chips (e.g., for exceedingly large denominations).

In some embodiments, an RFID-enabled chip may be an active chip which includes its own battery or power source. In other embodiments, an RFID-enabled chip may be a passive chip which does not include its own power source. In one embodiment, an electronic circuit and antenna of a given chip may act as a transponder capable of responding to an antenna of the table (e.g., an antenna of an RFID-enabled chip tray of the table). The antenna may be a sensor or other detecting component operable to detect, recognize, determine, identify or sense the presence (or absence) of an RFID-enabled chip, a wagering chip having optically detectable indicia or data encoded thereon or another type of gaming element. The antenna or other detecting component may also be operable to detect, determine, identify, recognize or receive various information about a chip (e.g., chip identifier, chip set identifier, chip denomination, chip status, etc.). The antenna, imaging device or other detecting component of a table or chip tray may also be operable to transmit information to one or more processors or memories of a game controller or other computing device (e.g., information regarding the presence or absence of a chip in a certain location, an identifier of a chip, etc.). Such one or more processors or memories may be components of (i) a table, (ii) a component of a table (e.g., of a dealer display or chip tray) and/or (iii) a server device operable to communicate with one or more tables.

In accordance with some embodiments, an antenna of a table (e.g., an antenna of the set of antennas 210a and/or an antenna 220A of a chip tray) may send out an electromagnetic signal that impinges upon the antenna of an RFID-enabled chip, exciting a current within electronic circuit of the chip. In response to the excited current, the electronic circuit of the chip may cause the antenna of the chip to emit a second electromagnetic signal as a response, which is received by the antenna of the table which had sent out the electromagnetic signal. The second signal may comprise identifying information about the chip such that the antenna can identify the chip on receipt of the second signal. The second signal may be generated passively or actively. That is, in a first embodiment, the energy from the interrogation signal provides sufficient power for the electronic circuit of the chip to use to send the second signal. In a second embodiment, the electronic circuit of the chip may include a battery or other power source, which is used to power the generation of the second signal.

In accordance with some embodiments, an antenna or other detecting mechanism of a table (e.g., an antenna or other detecting mechanism of a physical wager placement position that is operable to detect the presence (or lack thereof) of a gaming element on the physical wager placement position) may also be operable to transmit information to one or more processors or memories (e.g., information regarding the presence, absence or movement of a chip in a certain location, an identifier and/or denomination of a chip, etc.). Such one or more processors or memories may be components of (i) a table system, (ii) a component of a table system (e.g., of a dealer display or chip tray) and/or (iii) a server device operable to communicate with one or more table systems. In accordance with some embodiments (e.g., when referring to a processor or controller of an electronic gaming table system as described herein), such one or more processors and memories may be referred to as a “game controller” or Core Gaming System (CGS). As described in more detail elsewhere herein, a game controller or CGS may be operable to perform certain functions with respect to a smart table, such as (i) controlling the polling (e.g., reading or requesting data from) one or more RFID antennas or other detecting components of the table system; (ii) analyzing or interpreting such data to determine wagering activity at the physical table; (iii) processing such data to determine actions, outputs or signals that should be undertaken based on such data (e.g., an optimized payout action plan and/or instructions to a dealer defining such optimized payout action plan) and/or (iv) storing chip placement information (e.g., information about RFID-enabled wagering chips located at chip location positions of the table, such as the identifiers and/or denominations of wagering chips and which chip location positions they have been detected on). A game controller or CGS may comprise specialized hardware, software or a combination of hardware and software, operable to perform at least some of the functionalities described herein.

In one embodiment, a CGS may poll one or more antennas or other detecting components of an electronic gaming table (e.g., in accordance with a schedule or program and/or in response to events in a hand being played on the table) in order to obtain or receive data therefrom. Thus, in some embodiments, the CGS may received data from one or more RFID antennas upon polling the antenna and requesting such data (in other embodiments an RFID antenna may more proactively transmit data to the CGS or another processor independent polling functionality). In accordance with some embodiments the CGS may determine, based on the data received from one or more RFID antennas, (i) information that should be output on a dealer display and/or one or more dealer displays, (ii) a payout that should be made to a player; (iii) a commission that should be collected by a dealer; (iii) whether an additional wager may be accepted based on a status of a game event; (iv) an optimized payout action plan for a particular game event and/or player or player position, and instructions for the dealer that define such optimized payout action plan.

Referring now to FIG. 3, illustrated therein is a planar view of a smart table 300, which may be operable to facilitate one or more embodiments described herein. The table 300 may comprise the table of FIG. 2, but with a felt or other covering hiding the antennas placed underneath. In many respects, the smart table 300 may appear to a player as a regular baccarat table, with the RFID capabilities of the table not being readily discernable. The table 300 is configured for a baccarat game but the embodiments described herein are not limited to baccarat and a similar table may be provided with a top layout appropriate for facilitating another game (e.g., blackjack, roulette or poker).

The rules of baccarat are well understood, but the interested reader is directed to www.wizardofodds.com/baccarat for a more detailed explanation. Table 300 comprises a smart table configured to facilitate a baccarat game and includes a dealer area within which is located a dealer display 322 and an RFID-enabled chip tray 320. The dealer display may be utilized to output data or prompts to a dealer during the course of game play (e.g., to output instructions defining an optimized payout action plan). The player display may be utilized to output data or prompts to a player during the course of game play (e.g., to output results of an optimized payout action plan)

The table 300 further includes seven (7) player positions 310a-310g, each player position including a Banker bet spot and a Player bet spot. In some embodiments, one or more of a player position may include areas for placing one or more side bets (via “side bet spots”). In some embodiments, each player position may comprise a single bet spot (e.g., in a Blackjack or other type of card game). Of course, any number of player positions may be utilized. Further, in some embodiments the table may include bet spots in addition to bet spots at player positions, such as shared or common bet spots.

The table 300 further includes a display 340 which a dealer or other gaming establishment personnel may utilize to access information regarding game events, transactions and other data related to the table 300.

The table 300 further includes another display 350 which faces the players and may show data to players such as recent historical outcomes (sometimes referred to as a “trend board”). Players sometimes use such historical outcomes in an effort to predict trends within a series of game instances. In some embodiments, the display 350 may output a virtual representation of the table and/or wager status on all wager placement positions, including any virtual bets placed by remote players.

The table 300 further includes an electronic card shoe 360 via which cards for the game are dealt and, in some embodiments, shuffled (in other embodiments cards are shuffled outside the shoe or pre-shuffled cards are used within the shoe or a shoe is not utilized at all). In accordance with some embodiments, the electronic card shoe 360 may communicate with a processor (e.g., a processor of the table 300, such as a process of a game controller component of the table 300) to communicate data regarding cards dealt and/or remaining in the shoe.

The table 300 may include additional components (at least some of which may not be easily visible to a player or other observer) such as one or more processors, a memory storing a general program and one or more specialized software applications which, in combination with data obtained from the RFID antennas located on the table, may facilitate many of the functions described herein (e.g., processing Change Transactions, tracking a status of chips or an update in a status of a chip).

Referring now to FIG. 4, illustrated therein is a block diagram of a table system 700 consistent with some embodiments described herein. The table system 700 may comprise, for example, a table system 120 of FIG. 1. The table system 700 may be implemented as a system controller, a dedicated hardware circuit, an appropriately programmed computer which is a component or peripheral device of a table for facilitating a card game, or any other equivalent electronic, mechanical or electro-mechanical device.

The table system 700 comprises a CGS 750, which includes at least one a processor 784, such as one or more INTEL® PENTIUM® processors. The processor 784 may be in communication with a memory 790 and a communications port 780 (e.g., for communicating with one or more other devices). The memory 790 may comprise an appropriate combination of magnetic, optical and/or semiconductor memory, and may include, for example, Random Access Memory (RAM), Read-Only Memory (ROM), a compact disc, tape drive, and/or a hard disk. The memory 790 may comprise or include any type of computer-readable medium. The processor 784 and the memory 790 may each be, for example: (i) located entirely within a single computer or other device; or (ii) connected to each other by a remote communication medium, such as a serial port cable, telephone line or radio frequency transceiver. In some embodiments, the table system 700 may comprise one or more devices that are connected to a remote server computer for maintaining databases.

The memory 790 may store a program 790A for controlling the processor 784. The processor 784 may perform instructions of the program 790A, and thereby operate in accordance with at least one embodiment described herein. The program 790A may be stored in a compressed, uncompiled and/or encrypted format. The program 790A may include program elements that may be necessary or desirable, such as an operating system, a database management system and “device drivers” for allowing the processor 784 to interface with computer peripheral devices (e.g., detecting components such as the RFID antenna, an RFID-enabled chip tray, an electronic shoe, a camera, any of which may provide data to the processor 784). Appropriate program elements are known to those skilled in the art, and need not be described in detail herein. In accordance with some embodiments, program 790A, a subroutine or module of program 790A or another program stored in memory 790 (or otherwise accessible to processor 784) may comprise instructions for applying at least some of the processes or functionalities described herein (e.g., determining and/or confirming, based on data received from at least one detecting component, an optimized payout action plan for a particular game event).

The term “computer-readable medium” as used herein refers to any medium that participates in providing instructions to processor 784 (or any other processor of a device described herein) for execution. Such a medium may take many forms, including but not limited to, non-volatile media, volatile media, and transmission media. Non-volatile media include, for example, optical or magnetic disks, such as memory 790. Volatile media include dynamic random access memory (DRAM), which typically constitutes the main memory. Transmission media include coaxial cables, copper wire and fiber optics, including the wires that comprise a system bus coupled to the processor 784. Transmission media can also take the form of acoustic, electromagnetic, or light waves, such as those generated during radio frequency (RF), microwave, and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Various forms of computer readable media may be involved in carrying one or more sequences of one or more instructions to processor 784 (or any other processor of a device described herein) for execution. For example, the instructions may initially be borne on a magnetic disk of a remote computer. The remote computer can load the instructions into its dynamic memory and send the instructions over a telephone line using a modem. A modem local to a table system 700 may be operable to receive the data on the telephone line and use an infrared transmitter to convert the data to an infrared signal. An infrared detector can receive the data carried in the infrared signal and place the data on a system bus for processor 784. The system bus may carry the data to a main memory, from which processor 784 may retrieve data and execute instructions. The instructions received by main memory may optionally be stored in memory 790 either before or after execution by processor 784. In addition, instructions may be received via communication port 780 as electrical, electromagnetic or optical signals representing various types of information. According to some embodiments of the present invention, the instructions of the program 790A may be read into a main memory from another computer-readable medium, such from a ROM to RAM. Execution of sequences of the instructions in program 790A may cause processor 784 to perform at least some of the functions described herein. In alternate embodiments, hard-wired circuitry may be used in place of, or in combination with, software instructions for implementation of at least one embodiment described herein. Thus, embodiments described herein are not limited to any specific combination of hardware and software.

The memory 790 may also store at least one database, such as chip location database 790B. In some embodiments, some or all of the data described herein as being stored in the database 790B may be partially or wholly stored (in addition to or in lieu of being stored in the memory 790 of the table system 700) in a memory of one or more other devices, such the table game server 110 (FIG. 1). In accordance with some embodiments, the chip location database may store chip identification data and/or chip location data. For example, the chip location database may store an indication of where on the table a particular chip is located and/or a status associated with that location, such as whether it is located at a player position and is part of a wager being made by a player or in a chip tray and available for the dealer's use in making payouts and the specific player or dealer (tips) ownership of each chip. In some embodiments, the chip location database 790B and/or another database of memory 790 may store other data defining a given chip, such as denomination, unique chip identifier (e.g., UUID), chip set identifier, gaming establishment identifier, chip value, player identifier associated with chip identifier, bankroll identifier associated with a chip identifier, validity of chip, etc. In some embodiments, the memory 790 may store additional data regarding movement, location or wagering activity which has occurred on the table. For example, chip movement history (e.g., an indication of which antennas or table bet positions a particular chip has been acquired at, a time at which it was acquired at a particular antenna, a time at which it was determined to no longer be at that antenna, etc.) may be stored. In some embodiments, a history of chip movements may be stored (e.g., in a file-based archive log) on another device (e.g., in a memory of table game server 110 of FIG. 1).

In some embodiments, chip status database 790 or another table or memory device may be used to dynamically track stacks of chips or wagers for a game event. For example, the database or table may be updated as data is received from the dealer antenna (e.g., based on inventory chips being placed onto and then removed from a dealer antenna) and the CGS 750 may determine whether to change the status of the chips from inventory to non-inventory based on rules for determining such status. The CGS may be programmed (e.g., via program 790A) to recognize that if one or more inventory wagering chips the value of which is equal to an amount to be paid out to a player for a winning wager are placed onto and then removed from the dealer antenna the status of each of those chips should be changed to non-inventory since they are presumed to be now paid out to the appropriate player as a result of the winning wager.

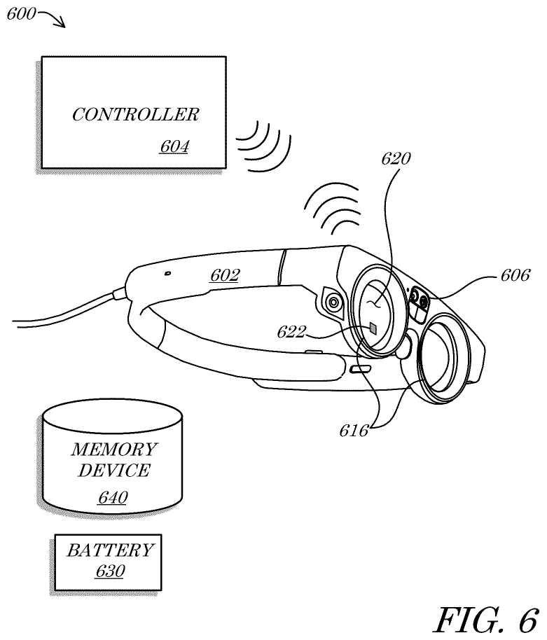

The processor 784 is also operable to communicate with one or more display devices: (i) a dealer display 758 (e.g., one or more displays such as display 340 and/or display 322 of FIG. 3) and a second display 770. The second display 770 may comprise, for example, a display for displaying historical outcomes or other game information to a player (e.g., a trend board, such as described with respect to display 350 of FIG. 3) or another type of player display. In some embodiments, a player display can show a myriad of information to the players, such as information related to optimized payout action plans. For example, a player display may output an indication of the bet amount for a particular wager or game event and/or the optimized payout amount or optimized payout action plan. The dealer display 758 may output information such as (i) instructions for implementing an optimized payout action plan, in accordance with embodiments described herein; and/or (ii) other information regarding a status of a game event, including information regarding a status of one or more wagers or RFID-enabled chips being used on the table. In some embodiments, one or both of the displays 758 and 770 may include or have associated therewith its own processor, memory and program (and may be operable to communicated data to and/or from the processor 484). Either of the display devices 758 and 770 may comprise, for example, one or more display screens or areas for outputting information related to game play on the gaming system, such as a cathode ray tube (CRT) monitor, liquid crystal display (LCD) screen, or light emitting diode (LED) screen. In some embodiments, either of the display devices 758 and 770 may comprise a touch screen. In some embodiments, at least some of the information described herein as being output via display 758 and/or display 770 may additionally, or alternatively, be output via the MR device 600 described with respect to FIG. 6.

As described herein, in some embodiments an RFID-enabled chip tray may comprise one or more antennas for reading information from RFID-enabled chips placed in the chip tray. In such embodiments, the processor 784 is further operable to communicate with the one or more chip tray antenna(s) 760A. The one or more antenna(s) 760A may be operable to read data from one or more chips placed within a chip tray (e.g., chip identifier, chip set identifier, chip denomination, etc.). In accordance with some embodiments, the CGS is programmed to recognize a chip that is detected as having been placed on a wager placement position as a payout chip if that chip was recognized by the CGS as being in the chip tray (e.g., based on data received from the chip tray antenna(s) 760A immediately prior to being detected on the wager placement position.

The processor 784 is further operable to communicate with a shared position antenna 760C, which comprises at least one antenna on a shared or common betting area for recognizing chips placed (and/or removed from) the shared or common betting area.

The processor 784 is further operable to communicate with a plurality of detecting components (e.g., RFID antennas or optical imaging components) at physical player stations (also referred to as physical player positions) of the physical table. As described with respect to FIGS. 2 and 3, in some embodiments each physical player position of a physical table may have a corresponding Player bet spot area and a Banker bet spot area (either of which may, in some embodiments, include a plurality of side bet spot areas and each such area may have associated therewith its own antenna or other detecting component for determining that a wagering chip or other gaming element has been placed within this area and thus that a wager has been placed on either the Player win outcome, the Banker win outcome or a plurality of side bet outcomes. The table system 700 illustrates three player positions 756 (756a, 756b and 756c) as each having two detecting components associated therewith: a Player Bet detector 796 and a Banker Bet detector 798. Thus, player station 756a has associated therewith Player Bet detector 796A and Banker Bet detector 798A, player station 756B has associated therewith Player Bet detector 796A and Banker Bet detector 798B and player station 756C has associated therewith Player Bet detector 796C and Banker Bet detector 798C.

It should be noted that the example table system 700 is depicted as a table for facilitating a baccarat game and therefore the layout of the various components and player positions thereof reflects that of a baccarat game. In other embodiments, the systems and methods described herein may be implemented for a different type of wagering game (e.g., a poker, blackjack, Pai Gow or roulette game), in which cases the layout of the table and/or the detecting components may be adjusted accordingly. For example, for a poker or blackjack game, there would not be a need for both a Player Bet detector 796 and a Banker Bet detector 798 at each player position (e.g., a single detector at each player position may be sufficient).

Returning again to the example table system 700, each detecting component may be uniquely identifiable by, for example, (i) a unique identifier associated therewith, and (ii) an identification of a port or other component of the table associated with the antenna (e.g., the port into which the antenna is plugged into may have a unique identifier associated therewith) and such unique identifier may be transmitted to or recognized by the processor 784 when chip information regarding a chip acquired by a respective detecting component is transmitted to the processor 784, such that the processor 784 may be programmed to determine which player position and which wager placement position within the player position the wagering chip has been placed on. In some embodiments, the chip location database 790B may store detailed data with information regarding chips identified at a table, such details being associated with a chip identifier of each chip for which data is stored (e.g., chip value, chip denomination, chip set identifier, bankroll identifier or other indicator of a category or characteristic associated with a chip, time of acquisition, which stack or wager the chip is associated with, etc.). Storing such data at the table may allow for faster RFID scanning or other detecting, since the system will not need to obtain a lot of data every time a chip is acquired or recognized by an antenna or other detecting component of a table (e.g., only the chip identifier may be necessary and additional information, such as whether the chip is an inventory chip or a non-inventory chip, may be looked up by the system based on the chip identifier from a local database or memory).

In some embodiments, the CGS 750 is further operable to communicate with an electronic shoe 764. The shoe 764 may be an intelligent shoe such as the IS-T1™ and IS-B1™ or the MD1, MD2 sold by SHUFFLE MASTER or other such devices. The shoe 764 may be able to determine which cards are being dealt to which player station, through RFID technology, image recognition, a printed code on the card (such as a barcode), or the like. The embodiments described herein are not dependent on any particular technique used to recognize cards dealt in a card game (or cards remaining as available to be dealt). Further information about intelligent shoes may be found in U.S. Pat. Nos. 5,941,769 and 7,029,009, both of which are incorporated by reference in their entireties and U.S. Patent Application Publications 2005/0026681; 2001/7862227; 2005/0051955; 2005/0113166; 2005/0219200; 2004/0207156; and 2005/0062226 all of which are incorporated by reference in their entireties. In place of an intelligent shoe, cameras, such as may be used with pattern recognition software to detect what cards have been dealt to what player stations and what chips have been wagered at particular player stations. One method for reading data from playing cards at table games is taught by German Patent Application No. P44 39 502.7. Other methods are taught by U.S. Patent Application Publication 2007/0052167 both of which are incorporated by reference in their entirety.

The CGS 750 is further operable to communicate with a dealer station antenna 760B, which comprises one or more antennas placed in a dealer area of the corresponding table. The dealer station antenna 760B may be operable to detect RFID-enabled chips which have been placed within its acquisition area, such as chips the dealer places in the area for recognizing by the system prior to placing them into the dealer tray or paying them to a player.

It should be noted that although instructions to a dealer for effectuating an optimized payout action plan have been described in various examples as being output to a dealer via a dealer display, other output devices may be part of the systems and methods described herein and utilized to output instructions or other information about a game event to a dealer. For example, wearable output devices, such as ear buds (or other audio output devices) or augmented reality glasses may be used to output instructions to a dealer. For example, Applicant has recognized that the advent of amplified pass-through ear pieces the dealer can wear an ear bud or other audio device in order to receive an optimized payout action plan while still hearing the players or other audio information in the dealer area. For example, in some embodiments a dealer may be instructed via a wearable audio output device to “pay position 2 $500 and take $25” (in lieu of or in addition to having such instructions output via a dealer display). In some embodiments, the dealer may be able to press a button or otherwise request a repeat to get the instructions a second time.

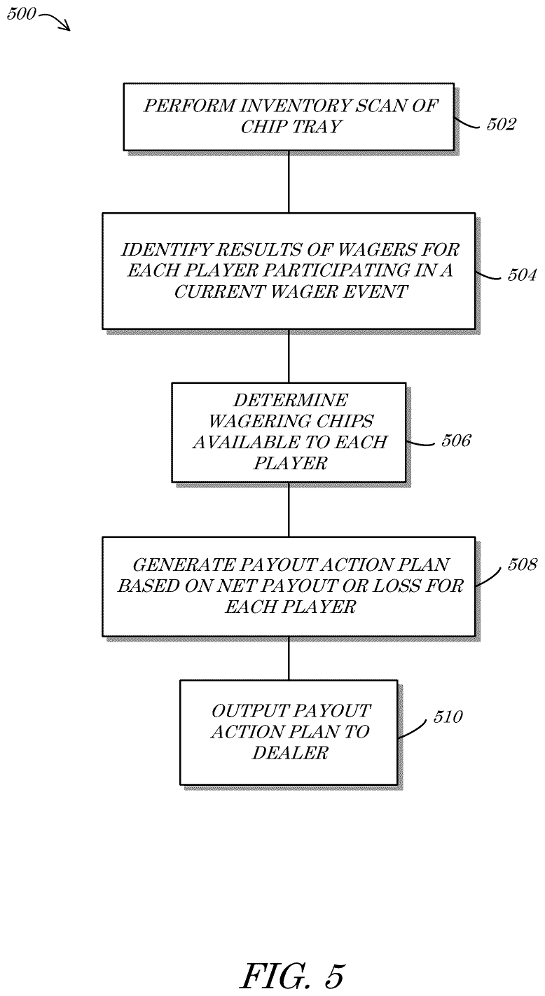

Referring now to FIG. 5, illustrated therein is a flow diagram of an example process 500 that is consistent with at least some embodiments described herein. Process 500 comprises a process for implementing at least some of the embodiments described herein, such as embodiments providing for generating and outputting to a dealer a payout action plan upon a result of a wagering event being determined.

In one embodiment, at least a portion of process 500 may be performed continuously or repeatedly by a game controller during a game event (e.g., during a round or deal of a card game), or may be triggered or initiated upon a certain phase or step of a game event being identified (e.g., once a result of a game event has been determined). Process may be performed, for example, by at least one of a server device operable to facilitate the provision of payout activity for a game (e.g., a card game). For example, the process 500 may be performed by at least one of (i) a table system 120 (FIG. 1); (ii) a table game server 110 (FIG. 1); (iii) CGS 790 and/or processor 784 (FIG. 4); and/or (iv) controller 604 (FIG. 6). Additional and/or different steps may be added to those depicted. Not all steps depicted are necessary to any embodiment described herein. Some steps may be performed in an order different than that depicted in FIG. 7 (e.g., the inventory scan of step 702 may be performed later in the process 700 and not as a first step of the process 700).

Process 500 may comprise a subroutine of a more general program. In one embodiment, process 500 may comprise at least a part of program 790A (FIG. 4). Process 500 is one example process of how some embodiments described herein may be implemented and should not be taken in a limiting fashion. A person of ordinary skill in the art, upon contemplation of the embodiments described herein, may make various modifications to process 500 without departing from the spirit and scope of the embodiments in the possession of applicants.

In step 502, an inventory of wagering chips available to a dealer facilitating a wagering game (e.g., for effectuating one or more payouts resulting from a game event) is determined. This may comprise, for example, identifying data of each wagering chip in the chip tray, including the denomination thereof. In one embodiment, such data defining the inventory of the chip tray may be obtained via the at least one chip tray antenna 760A (FIG. 1), which may be configured to perform an inventory scan to identify the current contents of the chip tray (e.g., to determine the total value of chips in the chip tray and/or detect identifiers of each individual chip detected in the chip tray or other characteristics of each chip, such as denomination or chip set identifier). In one embodiment, a processor of a table system (e.g., processor 784) may direct the chip tray antenna(s) directly while in other embodiments the chip tray may have its own processor to communicate with the chip tray antenna(s) and relay instructions from the table system processor.

In step 504, the results of all wagers placed for a given wagering event (e.g., a hand of a card game). This may comprise, for example, determining each wager placed at each player position (including the monetary value of each wager) and the result of that wager (i.e., did the player win or lose their wager and, if they won, what is the monetary value won). This information may be obtained, for example, via the various components of the smart table on which the wagering game is being conducted. For example, the amount wagered (and, if relevant based on the type of game, the nature of the bet) by each player may be determined via the one or more detecting components at the relevant player station 756 of each player position (e.g., RFID-enabled wagering chips placed by the player may be read by an RFID antenna or information encoded optically on each wagered chip may be read by an optical/image detecting component). The results of each wager may be determined by detecting the cards dealt or otherwise as described in commonly-owned U.S. Pat. Nos. 9,919,201, 9,262,885, and 10,755,520.

In step 506, the wagering chips available to (or associated with) each player participating in the wagering event is determined. This may comprise determining the denomination of each such wagering chip and the number of chips of each such denomination (e.g., that the player has three (3) $20 chips and two (2) $10 chips). In some embodiments, this may consist of identifying the wagering chips that the player otherwise has available, such as wagering chips in the player's bankroll. For example, the system may be able to determine, based on other information available to it, what additional wagering chips the player is associated with or in possession of (e.g., as stored in chip location database 790B of FIG. 4). A purpose of step 706 may be to determine what wagering chips, for a given player, are available to the dealer to take in order to effectuate a net payout in accordance with a payout action plan. While in some embodiments these may be limited to wagering chips the player has actually wagered or placed at a player position for the current wagering game event, in other embodiments this may further encompass other wagering chips of the player.

In step 508, a payout action plan is generated based on the net payout to be provided to a given player and/or the loss to be collected from a given player. For example, if it is determined that a player has won his/her wager, the net payout may be calculated based on the amount wagered and the rules of the game and any commission is deducted. If it is determined that a player has lost his/her wager, the amount to be collected may simply be the amount wagered.

As described, a payout action plan is generated to instruct a dealer exactly how many wagering chips (and the denomination of each such chip) to collect and/or pay out to a given player position at the resolution of a wagering game event. In accordance with some embodiments, the payout action plan may be generated based on one or more payout efficiency optimization rules. A payout efficiency optimization rule is designed to optimize the efficiency of how the dealer provides the appropriate payout due to a particular player and/or all payouts due to all players for the particular game event. For example, a payout efficiency optimization rule may define optimized payout efficiency as having the dealer provide the appropriate payout(s) using as few wagering chips of different denominations as possible, given base chip data. In some embodiments the payout efficiency optimization rule may define leaving one or more losing wagers when the winning wagers payouts are greater than the losing wagers and having the dealer provide net amount using as few wagering chips as possible. In some embodiments, base chip data may comprise one or more of (i) data defining the wagering chips (including number and denomination of each) currently in inventory in the wagering chip tray of the table system (e.g., as determined via the at least one second detecting component); and (ii) data defining the wagering chips (including number and denomination of each) placed/wagered by a given player on a player position on the game event (e.g., as determined via the at least one first detecting component).

In accordance with some embodiments, the electronic gaming table system may additionally be operable to determine a bankroll of a particular player to whom a payout is due. In such embodiments, the base chip data may comprise data defining the wagering chips (including number and denomination of each) in a bankroll of a given player and a payout efficiency optimization rule may comprise a rule that provides for the dealer to remove one or more wagering chips from the player bankroll (or requesting the player to provide such wagering chips from the bankroll to the dealer) as part of providing the payout due to the player or is directed to replenishing chips of a particular denomination into the player bankroll. For example, a payout efficiency optimization algorithm may determine that an optimized payout action plan should instruct a dealer to provide to a particular player more of a specific denomination chip that the system recognizes as being a favored one that the player historically uses for making wagers because the player's known owned set of chips (the player's bankroll) is low or out of chips of that specific denominations.

In some embodiments, a module or subroutine of a controller (e.g., CGS 750) may be operable to generate a payout action plan based on data it is receiving from the various elements of system 700. In some embodiments, the module or subroutine may be AI-assisted, to maximize the efficiency of the payout action plan. In some embodiments, Machine Learning (ML) algorithms may be further utilized to continuously train the AI-assisted module, to improve the efficiency of dealer movements or satisfy the goals of any payout efficiency rules being implemented by the module. For example, as dealers effectuate payout action plans generated by the module, the module may receive inputs that allow it to determine whether any desired objectives of the payout efficiency rules are being satisfied or can be further improved (e.g., the AI algorithm may determine, by tracking and analyzing such inputs, that there it is more beneficial or time efficient to have dealers provide larger number of wagering chips and not remove any chips (or minimize the number of wagering chips being removed) when making net payouts, because the math is easier for players to understand and there are fewer delays caused by the dealer having to explain his/her actions to the player.

In step 510, the payout action plan generated in step 508 is output to the dealer in the form of one or more instructions. The instructions may comprise instructions regarding (i) a particular player and/or player position and/or (ii) all players and/or player positions participating in the game event. For example, the dealer may be provided such instructions via a headset, virtual reality glasses, a heads-up display and/or a screen of a dealer device or other display device of a table (e.g., dealer display 758, second display 770 and/or a device such as MR device 602 of FIG. 6). In some embodiments, the payout action plan may also be output to the one or more players that are effected, such as via one or more displays of the table visible to the players or via a player's mobile device (e.g., to make it easier for the players to understand what the dealer is doing).

It should be noted that, while process 500 is depicted in the context of a payout action plan for each player participating in a wagering game event, such that the payout action plan output to a dealer may define all actions the dealer is to take with respect to all such players, in other embodiments a payout action plan may be generated and output per player. For example, in one embodiment a payout action plan generated at the payout phase of a wagering game event, as illustrated in the non-limiting example of FIG. 5, may comprise instructions such as the following (the Transaction ID being a non-limiting example of a unique identifier that may be generated and assigned by the system to a given payout action plan and/or wagering event):

Payout Action Plan for Transaction ID 17383910-27

| Player | | Wagering Chips to | Wagering Chips to |
|---|---|---|---|
| Position | Net Payout | be Removed | be Paid Out |
| 1 | $75 | 1 × $25 | 1 × $100 |
| 2 | $95 | 1 × $5 | 1 × $100 |
| 3 | $135 | 1 × $5 | 1 × $100 |
| | | | 2 × $20 |

It should be noted that in some embodiments, other types of representations and/or graphics may be utilized to depict information to a dealer as part of a payout action plan. For example, graphics representing the wagering chips may be used (e.g., in color, so that the appropriate color is used to denominate the corresponding denomination), in a way that is visually helpful to the player to understand how many wagering chips of each denomination the dealer is to remove and/or pay out to a given player position. In other embodiments, a payout action plan may be generated per player position and output to the dealer one player position at a time. For example, in an embodiment in which a payout action plan is output via VR goggles or an MR device 602 (e.g., as described with respect to FIG. 6, below), as the dealer looks at each player position of a table at the payout phase of a wagering game event, the system may superimpose or output the payout action plan for that player position via the device.

Referring now to FIG. 6, illustrated therein is a perspective diagram of a system 600 that may be used in some embodiments to output information to a dealer of a wagering game. System 600 or a similar system may be used, for example, in embodiments in which instructions for a payout action plan are output to a dealer via augmented reality glasses, goggles or similar headgear (“AR glasses”). For example, payout instructions may appear as text and/or graphics on the glasses heads up display and persist until the payout action plan is successfully executed by the dealer.

In accordance with some embodiments, systems, apparatus, methods, and articles of manufacture for Mixed Reality (MR) and Artificial Intelligence (AI)-enhanced dealer assistance may be provided. In some embodiments, for example, an MR/AI-based dealer assistance system may utilize various sensors and wearable (e.g., head-mounted) computer hardware to: (i) acquire data (e.g., from a controller of a physical wagering game system, such as CGS 750 (FIG. 4); one of table game server 110 or table system 120 (FIG. 1), and/or directly from one or more detecting components of a wagering game system such as RFID antennas, NFC readers or optical/imaging detection components); and (ii) output information, such as instructions or results of an analysis of such data, to a dealer of the wagering game. Such a system 600 may enhance and make more efficient a dealer's ability to identify, analyze and/or accurately or optimally act upon such information. For example, a payout action plan and/or instructions for the dealer may output via the system 600. In some embodiments, the system 600 may output information akin to a heads-up display output to operators of vehicles, providing information helpful to the operator (in a 2-D or 3-D manner), that augments the dealer's ability perform certain functions in a timely manner while being presented with relevant information, warnings, and/or instructions without having to look at a separate display screen. For example, the result of a wagering event (for a given player or all players of a game) may be superimposed on a view of the table, with an indication of payouts to be made and commissions and/or losses to be collected. In some embodiments, warnings or cautions about potentially problematic events or actions may also be output (e.g., that a player placed a late bet, removed a wagering chip or otherwise engaged in a problematic behavior). In some embodiments, marketing offers or promotions to be offered to one or more players may be output for the dealer, prompting the dealer with the information and/or specific words to be spoken to the one or more players. In some embodiments, the timing and/or content of any such information output to the dealer via the system 600 may be based on events occurring at the table game as fed into the system based on the one or more sensors, detecting elements and/or controllers communicating with the system 600.

In some embodiments, the system 600 may comprise a wearable MR device 602 that may be in wireless communication with a controller 604 (e.g., CGS 750 (FIG. 4); or one of table game server 110 or table system 120 (FIG. 1)), may comprise a sensor 606, such as one or more cameras (e.g., at least one low-resolution camera, in some embodiments) and/or other detecting component as described herein (e.g., an RFID antenna of a player position, a dealer position, or a chip tray or other container, as described herein with reference to FIGS. 2-4 herein). A dealer or other user may wear the MR device 602 in an area of a casino in which an electronic wagering game system is located. In some embodiments, the MR device 602 may be operable to detect and/or identify (e.g., utilizing the sensor 606) or receive data from controller 604 defining one or more objects (not shown) in the environment, such as one or more gaming elements (e.g., wagering chips) placed on a table or other surface and/or located in a chip tray or other container for storing gaming elements. In some embodiments, the system 602 may comprise an image processing application, such as an AI-enabled object recognition program, executed by the MR device 602 or controller 604, to determine events or transactions occurring in a wagering game and/or generate instructions or information to be output to a dealer of the wagering game.

In some embodiments, the MR device 602 may comprise one or more display devices 616, such as the dual-lens, wearable, see-through, “glasses”-style display device 616 depicted in FIG. 6. The physical arrangement, coupling, and/or cooperative orientation of the display device(s) 616 and the sensor 606 may facilitate the coordinate capturing and outputting of data in accordance with MR display techniques. The MR device 602 may utilize the captured data (e.g., as captured by sensor 606 and/or received from controller 604 to output, display, and/or project, via an interface 620, an indication or graphical representation of information to the dealer or other user wearing the MR device 602.

The graphical representation 622 may be selectively output on a particular portion of the interface 620 such that when the wearer looks through the display device 616 and the interface 620, the graphical representation 622 coincides with (and appears to be located at) the location of the table or table surface at which the dealer is currently looking. For example, if the dealer is looking at a particular player position, the interface 620 may depict a graphical representation 622 of a payout action plan generated for that player position as a result of a wagering game event.

According to some embodiments, the MR device 602 may comprise and/or be in communication with a battery 630 (e.g., that stores and/or provides power to the MR device 602) and/or a memory device 640. The memory device 640 may, for example, store data acquired by the sensor 606, data provided by controller 604 and/or that is descriptive of the environment. In some embodiments, the memory device 640 may be a component of controller 604 (e.g., it may comprise memory 790 of CGS 750).

Fewer or more components 602, 604, 606, 616, 620, 622, 630, 640, and/or various configurations of the depicted components may be included in the system 600 without deviating from the scope of embodiments described herein. In some embodiments, the components 602, 604, 606, 616, 620, 622, 630 and 640 may be similar in configuration and/or functionality to similarly named and/or numbered components as described herein.

In some embodiments, the MR device 602 or similar systems (e.g., AR glasses) may be utilized to output other information or prompts to a dealer. For example, (i) a current highest ROI and/or (ii) where to pass the cards being dealt (e.g., to avoid problems that occur when the dealer passes cards to the wrong player (the hand is usually voided if the wager loses for the player who should have squeezed the cards). Using a system such as the MR device 602 or AR glasses, the system can identify the correct player position for the highest wager on player and banker so the cards go to the correct players.

According to some embodiments, the MR device 602 may comprise any type or configuration of device, sensor, and/or system that is capable of capturing imagery and/or other data descriptive of a smart table environment as described herein and/or the objects, portions, gaming elements and/or attributes thereof. The MR device 602 may, in some embodiments, comprise a wearable computing device that provides MR capabilities to a wearer thereof. The MR device 602 may, for example, comprise a Magic Leap 2™ wearable MR unit available from Magic Leap, Inc. of Plantation, FL. The Magic Leap 2™ comprises an electronic processing device, a built-in memory device (e.g., two hundred and fifty-six Gigabyte (256 GB)), a twelve point six Megapixel (12.6 MP) autofocus Red-Green-Blue (RGB) video camera (e.g., with a seventy degree field of View (70° foV)), built-in audio speakers, four (4) IMU sensors (e.g., three-axis (3-axis) accelerometer and gyroscope; two (2) three-axis (3-axis) magnetometers; and two (2) altimeters), a see-through display (e.g., head-mounted, with one thousand four hundred forty by one thousand seven hundred sixty pixel (1440×1760) resolution and twenty to two thousand nits (20-2000) brightness, and a battery providing power to the various components. In some embodiments, the MR device 602 may comprise a wireless communication device (e.g., for communications via the controller 604) and/or a paired hand-held controller/pointer device (e.g., six (6)-degrees of freedom). In some embodiments, the sensor device 606 may comprise and/or include any or all of the input devices of the MR device 602.

Although various embodiments and examples have been described herein, other embodiments are within the scope of the present description as variations that are within the scope of what Applicant envisions. For example, in addition to outputting instructions for a payout action plan, similar processes and systems may be implemented to instruct the player on how to collect losing wagers and/or commissions in a manner that optimizes the efficiency of a dealer's actions, time and/or minimizes the number of chips a dealer has to handle and/or remove from a chip tray.

### Rules of Interpretation & General Definitions

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

The term “product” means any machine, manufacture and/or composition of matter as contemplated by 35 U.S.C. § 101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, LDP, rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as standard definition (SDTV), enhanced definition (EDTV), high definition (HD), or the like. The information may likewise be static, in which case, painted glass may be used to form the display. Note that static information may be presented on a display capable of displaying dynamic information if desired.

The present disclosure frequently refers to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, CPU devices, computing devices, microcontrollers, digital signal processors, or like devices. Exemplary processors are the INTEL PENTIUM or AMD ATHLON processors.

The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, Local Area Network (LAN), Wide Area Network (WAN), or Ethernet (or IEEE 802.3), Token Ring, or via any appropriate communications means or combination of communications means. Exemplary protocols include but are not limited to: BLUETOOTH™, TDMA, CDMA, GSM, EDGE, GPRS, WCDMA, AMPS, D-AMPS, IEEE 802.11 (WI-FI), IEEE 802.3, SAP, SAS™ by IGT, SUPERSAS™, OASIS™ by Aristocrat Technologies, SDS by Bally Gaming and Systems, ATP, TCP/IP, gaming device standard (GDS) published by the Gaming Standards Association of Fremont CA, the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cellular networks, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The present disclosure provides, to one of ordinary skill in the art, an enabling description of several embodiments and/or inventions. Some of these embodiments and/or inventions may not be claimed in the present disclosure, but may nevertheless be claimed in one or more continuing applications that claim the benefit of priority of the present disclosure.

What is claimed is:

1. A method for a processor to control an RFID-enabled electronic system for facilitating a wagering game, comprising:
receiving, by a processor of the electronic system, first data, the first data identifying a first plurality of gaming elements located in a gaming element container as identified by a gaming element container RFID antenna comprising a first component of the electronic system, the first data including the denomination of each gaming element of the first plurality of gaming elements;
receiving, by the processor, second data, the second data indicating a second plurality of gaming elements corresponding to a particular player position of the electronic system, the second data being derived by the processor from information received from at least one player position RFID antenna comprising a second component of the electronic system and including the denomination of each gaming element of the second plurality of gaming elements;
determining, by the processor, a result of a wager placed by a player corresponding to the particular player position;
calculating, by the processor and based on the result, a net payout to be paid out to the player;
generating, by the processor and based on the first data, the second data, the net payout, and a payout efficiency optimization rule, a payout action plan, wherein the payout action plan comprises an indication of an exact number of gaming elements of at least one specific denomination that the dealer is to at least one of provide and obtain from the player in order to effectuate the net payout in accordance with the payout efficiency optimization rule; and
directing, by the processor, a display associated with the electronic system to output an indication of the payout action plan to a dealer of the wagering game.

2. The method of claim 1, wherein generating comprises:
generating, by the processor, the payout action plan in a manner that satisfies at least one payout efficiency optimization rule.

3. The method of claim 2, wherein the payout efficiency optimization rule prioritizes efficiency of dealer movements.

4. The method of claim 3, wherein the payout efficiency optimization rule prioritizes efficiency of dealer movements in providing all net payouts for a given wagering game event.

5. The method of claim 2, wherein the payout efficiency optimization rule prioritizes minimizing the number of gaming elements that the dealer is to handle when executing the payout action plan.

6. The method of claim 2, wherein the payout efficiency optimization rule prioritizes providing, to the player, elements of the at least one denomination.

7. The method of claim 5, wherein the at least one denomination is a preferred denomination of the player associated with the particular player position.

8. The method of claim 2, wherein the payout efficiency optimization rule prioritizes minimizing the number of different denomination gaming elements that the dealer is to handle in providing the net payout.

9. The method of claim 1, wherein multiple players are participating in the wagering game and wherein the payout action plan is for all net payouts to be provided to each of the multiple players.

10. The method of claim 1, wherein the display comprises a display of virtual reality goggles worn by the dealer.

11. The method of claim 1, further comprising:
determining, by the processor, third data indicating a third plurality of gaming elements comprising the player's bankroll, and wherein generating comprises:
generating, by the processor and based on the first data, the second data, the third data and the net payout, a payout action plan.

12. The method of claim 1, wherein the payout action plan comprises an indication an exact number of gaming elements of at least one specific denomination that the dealer is to at least one of provide and remove from the particular player position in order to effectuate the net payout.

13. The method of claim 1, wherein the wagering game is a card game.

14. The method of claim 13, wherein the card game is baccarat.

15. An electronic table system for facilitating a wagering game, comprising:
a container for storing gaming elements that a dealer of the table utilizes to provide net payouts to players of the wagering game, the container being equipped with a first detecting component operable to detect a number and denomination of gaming elements stored in the container;
a plurality of player positions on which players place gaming elements when participating in the wagering game, each such player position being associated with at least one second detecting component operable to detect a number and denomination of gaming elements placed thereon;
a display device for outputting information to the dealer; and
a game controller operable to facilitate the wagering game by performing a method, the method comprising:
receiving first data from the first detecting component, the first data identifying a first plurality of gaming elements located in the container and including the denomination of each gaming element of the first plurality of gaming elements;
receiving second data from at least one of the second detecting component, the second data indicating a second plurality of gaming elements corresponding to a particular player position of the electronic table system, the second data including the denomination of each gaming element of the second plurality of gaming elements;
determining a result of a wager placed by a player corresponding to the particular player position;
calculating a net payout to be paid out to the player;
generating, by the processor and based on the first data, the second data, the net payout, and a payout efficiency optimization rule, a payout action plan, wherein the payout action plan comprises an indication of an exact number of gaming elements of at least one specific denomination that the dealer is to at least one of provide and obtain from the player in order to effectuate the net payout in accordance with the payout efficiency optimization rule; and
causing a display associated with the electronic table system to output an indication of the payout action plan to a dealer of the wagering game.

16. The electronic table system of claim 15, wherein at least one of the first detecting component and the second detecting component comprises an RFID antenna.

17. The electronic table system of claim 15, wherein at least one of the first detecting component and the second detecting component comprises an optical reader.

18. The electronic table system of claim 15, wherein generating comprises:
generating the payout action plan in a manner that satisfies at least one payout efficiency optimization rule.

19. The electronic table system of claim 18, wherein the payout efficiency optimization rule prioritizes efficiency of dealer movements.

20. The electronic table system of claim 19, wherein the payout efficiency optimization rule prioritizes efficiency of dealer movements in providing all net payouts for a given wagering game event.

21. The electronic table system of claim 18, wherein the payout efficiency optimization rule prioritizes minimizing the number of gaming elements that the dealer is to handle when executing the payout action plan.

22. The electronic table system of claim 18, wherein the payout efficiency optimization rule prioritizes providing, to the player, elements of the at least one denomination.

23. The electronic table system of claim 22, wherein the at least one denomination is a preferred denomination of the player associated with the particular player position.

24. The electronic table system of claim 18, wherein the payout efficiency optimization rule prioritizes minimizing the number of different denomination gaming elements that the dealer is to handle in providing the net payout.

25. The electronic table system of claim 18, wherein multiple players are participating in the wagering game and wherein the payout action plan is for all net payouts to be provided to each of the multiple players.
